(19) United States
(12) Patent Application Publication
(10) Pub. No.: US 2024/0409375 A1
(43) Pub. Date: Dec. 12, 2024

(54) CIVILIAN TRACKED VEHICLE, PROCESS TO RUN A CIVILIAN TRACKED VEHICLE AND SYSTEM WITH A CIVILIAN TRACKED VEHICLE

(71) Applicant: Kässbohrer Geländefahrzeug AG, Laupheim (DE)

(72) Inventors: Tobias PFETSCH, Blaustein (DE); Markus SCHMIED, Neu-Ulm (DE); Roman STRÖBELE, Staig (DE)

(21) Appl. No.: 18/736,833

(22) Filed: Jun. 7, 2024

(30) Foreign Application Priority Data
Jun. 9, 2023 (DE) 10 2023 115 146.0

(51) Int. Cl. B66C 13/54; B62D 55/06; B66C 13/48

(52) U.S. Cl. CPC B66C 13/54; B62D 55/06; B66C 13/48

(57) ABSTRACT

A civilian tracked vehicle having a support frame two sets of tracked running gear, a body frame arranged on the support frame, a driver's cab arranged at the front of the body frame, a drive system arranged on the body frame adjacent to the driver's cab and configured to provide drive energy, an implement carrier area arranged at the rear of the driver's cab for mounting different implements, a touchscreen arranged in the driver's cab with visualization content including operating information and operating commands, and a data processing device is connected to the touchscreen. A memory device is connected to the data processing device and stores a visualization data library with different visualization data sets associated with the implements. The data processing device reads specification data associated with one implement and selects a visualization data set as a function of the read specification data.

### CROSS-REFERENCE TO RELATED APPLICATION

This claims priority from German Application No. 10 2023 115 146.0, filed Jun. 9, 2023, the disclosure of which is hereby incorporated by reference in its entirety.

The invention relates to a civilian tracked vehicle having a support frame that extends longitudinally between a front and rear of the tracked vehicle, two sets of tracked running gear that are arranged on opposite longitudinal sides of the support frame, a body frame that is arranged on the support frame and extends longitudinally across the support frame from the front toward the rear, a driver's cab that is arranged at the front of the body frame, a drive system that is arranged on the body frame adjacent to the driver's cab and is configured to provide drive energy, an implement carrier area that is arranged at the rear of the driver's cab on the support frame and/or the body frame and is configured for mounting different implements, a touchscreen that is arranged in the driver's cab and has visualization content that is configured for outputting operating information and for inputting operating commands, and a data processing device that is connected to the touchscreen. The invention additionally relates to a method for operating such a civilian tracked vehicle and to a system including such a civilian tracked vehicle.

Such a civilian tracked vehicle is offered for sale by Kässbohrer Geländefahrzeug AG under the name PowerBully® and is intended for tasks in difficult terrain. Depending on the nature of the task, different implements can be mounted in the implement carrier area of the tracked vehicle. The known tracked vehicle has a touchscreen that is arranged in the driver's cab and has visualization content that is configured for outputting operating information and for inputting operating commands. The operating information comprises information about a functional state of the tracked vehicle itself and of the mounted implement. The inputtable operating commands, which can also be denoted control commands or “settings”, serve to control the tracked vehicle itself and the mounted implement. The different implements have different functions or functional ranges. Depending on the mounted implement, the visualization content of the touchscreen must consequently be adapted to the different functional ranges. Such adaptation has hitherto conventionally been carried out by the manufacturer before initial delivery of the tracked vehicle. Any subsequent change of implement may require a complex software update to adapt the touchscreen's visualization content.

US 2022/0396191 A1 moreover discloses a civilian tracked vehicle with a support frame, two sets of tracked running gear, a body frame, a driver's cab, a drive system and an implement carrier area. This known civilian tracked vehicle is also intended for tasks in difficult terrain.

The object of the invention is to provide a civilian tracked vehicle of the above-stated type, a method for operating such a tracked vehicle, and a system including such a civilian tracked vehicle that offer advantages over the prior art. The invention is in particular intended to enable versatile and cost-effective use.

Said object is achieved by providing a civilian tracked vehicle having the features of claim 1, a system having the features of claim 9 and a method having the features of claim 10. Further embodiments are stated in the dependent claims. The wording of the claims is incorporated by reference into the subject matter of the description.

For the civilian tracked vehicle, the object is achieved in that a memory device is present that is connected to the data processing device and in which is stored a visualization data library comprising a plurality of different visualization data sets, each of which is associated with one of the different implements, in that the data processing device is configured to read, from a specification data memory, specification data that are associated with one implement of the plurality of different implements mountable or mounted in the implement carrier area, in that the data processing device is configured to select a visualization data set from the plurality of different visualization data sets as a function of the read specification data, and in that the data processing device is configured to configure the visualization content of the touchscreen as a function of the selected visualization data set. The invention allows straightforward adaption of the visualization content of the touchscreen to the implement selected for a particular task. This enables particularly versatile deployment of the civilian tracked vehicle. The invention eliminates the need for time-consuming adaptation tasks to be carried out by the manufacturer or its customer service department. Instead, the visualization content of the touchscreen is automatically configured as a function of the implement arranged in the implement carrier area. Configuration of the visualization content may in particular be taken to mean adapting the outputtable operating information and the inputtable operating commands. This adaptation can be carried out in each case according to nature (or type) and/or scope. The visualization content is configured by way of the data processing device and as a function of the selected visualization data set. The visualization data set is part of the visualization data library. The visualization data library is stored in the memory device of the civilian tracked vehicle and comprises said plurality of different visualization data sets. One visualization data set is associated with each of the different implements. Different visualization data sets represent different visualization contents and thus differing natures and/or scopes of outputtable operating information and/or inputtable operating commands. The visualization data set in question is selected as a function of a specification or also of the functional range of the implement selected for the task in question and mounted or mountable in the implement carrier area. The specification of the implement is represented by its specification data. The specification data are read from said specification data memory by way of the data processing device. In one preferred embodiment, the specification data memory is arranged on the implement in question. In a further embodiment, the specification data memory is arranged remotely from the implement in question. Different specification data are associated with the different implements. Different specification data lead to the selection of different visualization data sets and ultimately to different configurations of the visualization content of the touchscreen.

In one embodiment of the invention, the different visualization data sets in each case comprise display data that represent different views of the implement in question in different perspectives and/or in different operating states. The different perspective views and/or views in different operating states are part of the (configured) visualization content of the touchscreen. The different views preferably show the civilian tracked vehicle together with the implement in question. The different perspectives allow the driver to be better informed. The same applies to the views of the implement/tracked vehicle in different operating states.

In a further embodiment of the invention, one implement of the plurality of different implements is mounted in the implement carrier area. In one embodiment, the implement arranged in the implement carrier area is detachably connected to the support frame. In a further embodiment, the implement is alternatively or additionally detachably connected to the body frame. In a further embodiment, the implement is connected to the drive system. In this case, the drive system provides the drive energy required to operate the implement.

In a further embodiment of the invention, the data processing device is connected to a data interface of the implement. This embodiment permits data exchange between the data processing device and the implement. The data interface is preferably a CAN bus. The data interface may, however, also be formed by another wired or wireless connection that is configured to transfer data and/or signals.

In a further embodiment of the invention, the implement includes the specification data memory, wherein the data processing device is configured to read the specification data from the specification data memory via the data interface. This is a preferred embodiment of the invention. In this embodiment, the specification data required for configuring the visualization content data are, in the broadest sense, part of the implement. For this purpose, the implement includes the specification data memory.

In a further embodiment of the invention, the data processing device is configured to receive implement operating parameters, and the visualization content of the touchscreen is configured to output the operating information as a function of the received operating parameters. In this embodiment of the invention, the operating information outputtable on the touchscreen is consequently variable depending on the operating state, and as a function of the operating parameters, of the implement. For this purpose, the data processing device is configured to receive said operating parameters. The operating parameters are preferably transferred via the data interface. If the implement is, for example, a dump body, the operating parameters may represent a dump body tilt angle. This tilt angle can then be displayed on the touchscreen as operating information as a function of the received operating parameters. This display is preferably provided in the form of a perspective view of the dump body (together with the civilian tracked vehicle). Depending on the received operating parameters, the dump body can be raised or lowered in the displayed perspective view or assume an intermediate position.

In a further embodiment of the invention, the implement has an actuator system that is connected to the drive system and is controllable via operating commands of the visualization content inputtable on the touchscreen. The different implements may have different actuator systems. The actuator systems may in each case comprise hydraulic, pneumatic and/or electrical actuators, for example in the form of actuating cylinders and/or servomotors. Different implements, and thus different actuator systems, require different operating commands. In this embodiment, the visualization content is automatically configured in the above-described manner.

In a further embodiment of the invention, the implement mounted in the implement area is selected from a group of different implements, wherein the group comprises a dump body, a lifting platform (main lift), an auger (digger derrick), a jib crane (areal crane), a vertical drilling rig (vertical drill), a telescopic crane, an articulated crane, a folding crane, a welding cabin, a shipping container, a flatbed (platform) and/or another implement.

The system according to the invention includes a civilian tracked vehicle according to the invention and a group of implements. The implements of the group are in each case mountable in the implement carrier area of the tracked vehicle. The group comprises a dump body, a lifting platform, an auger, a jib crane, a vertical drilling rig, a telescopic crane, an articulated crane, a folding crane, a welding cabin, a shipping container, a flatbed and/or another implement. In a preferred embodiment, the implements in each case include a specification data memory in which specification data are stored. The specification data differ for different implements and, on mounting the implement in question in the implement area of the civilian tracked vehicle, permit simple, automatic, preferably computer-assisted, configuration of the visualization content of the touchscreen.

The method according to the invention is provided for operating a tracked vehicle according to the invention and includes the steps of: selecting an implement from a group of different implements; mounting the selected implement in the implement carrier area; reading specification data of the mounted implement from a specification data memory by way of the data processing device; selecting a visualization data set from a visualization data library comprising a plurality of different visualization data sets, each of which is associated with one of the different implements, wherein selection is carried out by way of the data processing device and as a function of the read specification data; configuring the visualization content of the touchscreen, wherein configuration is carried out by way of the data processing device and as a function of the selected visualization data set; and operating the tracked vehicle as a function of configured visualization content of the touchscreen. In one embodiment, selection and mounting of the implement is carried out before initial delivery of the civilian tracked vehicle, i.e., by the manufacturer. In a further embodiment, selection and mounting of the implement is carried out by a user of the civilian tracked vehicle, i.e., after initial delivery and during the actual use of the civilian tracked vehicle. In one embodiment, the specification data are read from a specification data memory which is mounted away from the implement. In a preferred embodiment, the specification data memory is arranged on the implement and is part thereof. Reading the specification data, selecting the visualization data set and configuring the visualization content is carried out by way of the data processing device. The latter is configured accordingly. Configuration of the visualization content consequently takes place automatically and/or with computer assistance. This is in contrast to manual configuration, which is conceivable in principle, in which configuration commands are, for example, input on the touchscreen.

In a further embodiment of the invention, the selected visualization data set comprises display data that represent different views of the (selected and mounted) implement in different perspectives and/or in different operating states.

In a further embodiment of the invention, a data interface of the mounted implement is connected to the data processing device. The connection can be made by wire or wirelessly.

In a further embodiment of the invention, the mounted implement comprises the specification data memory, and the specification data are read from the specification data memory via the data interface. This is a preferred embodiment of the invention. Reading is carried out by way of the data processing device.

In a further embodiment of the invention, operating parameters of the mounted implement are transferred to the data processing device via the data interface, and the operating information is output on the touchscreen by way of the configured visualization content as a function of the transferred operating parameters.

In a further embodiment of the invention, an actuator system of the mounted implement is connected to the drive system, and the actuator system is controlled via operating commands of the configured visualization content that are input on the touchscreen.

Further advantages and features of the invention are revealed by the claims and by the following description of preferred exemplary embodiments of the invention, these being explained with reference to the drawings.

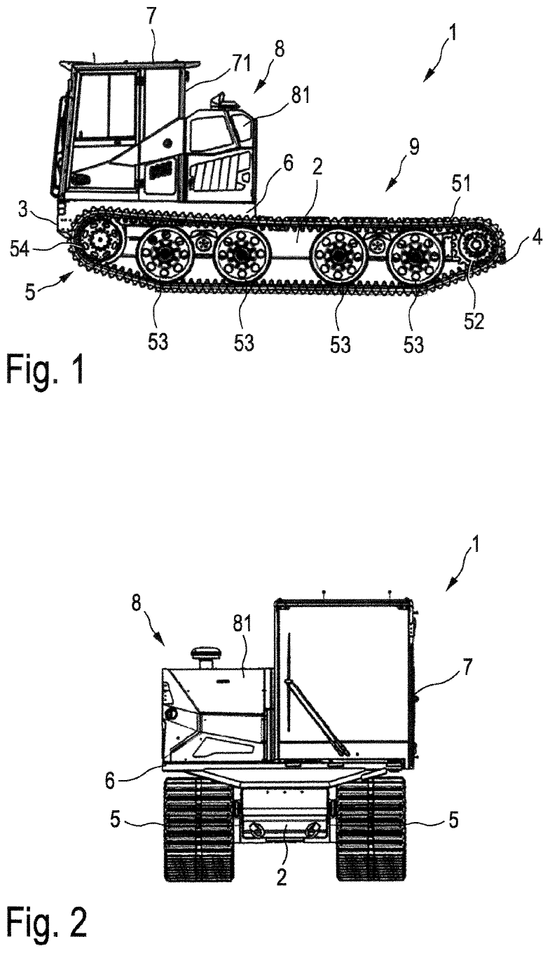

FIG. 1 shows a side view of an embodiment of a civilian tracked vehicle according to the invention,

FIG. 2 shows a front view of the civilian tracked vehicle of FIG. 1,

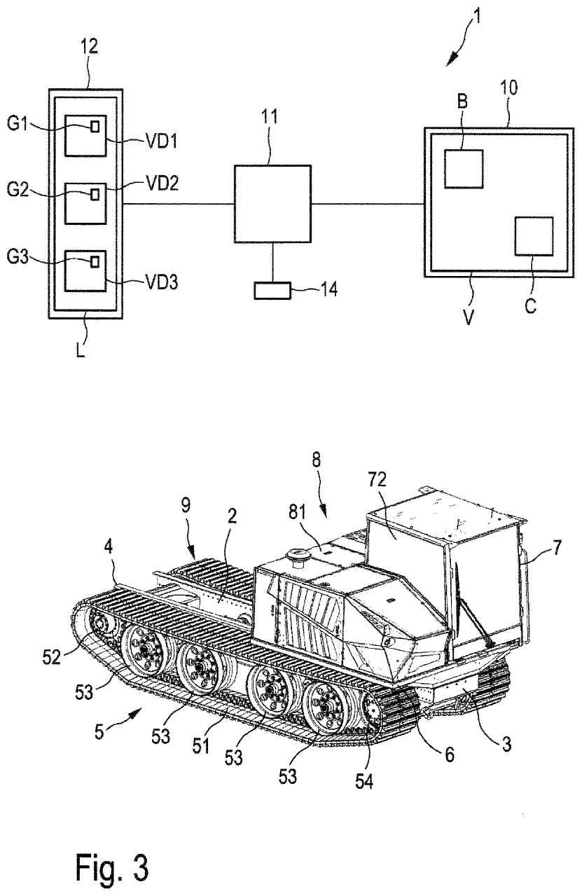

FIG. 3 shows a perspective view of the civilian tracked vehicle of FIGS. 1 and 2, wherein individual components of the civilian tracked vehicle are illustrated in a schematic block diagram,

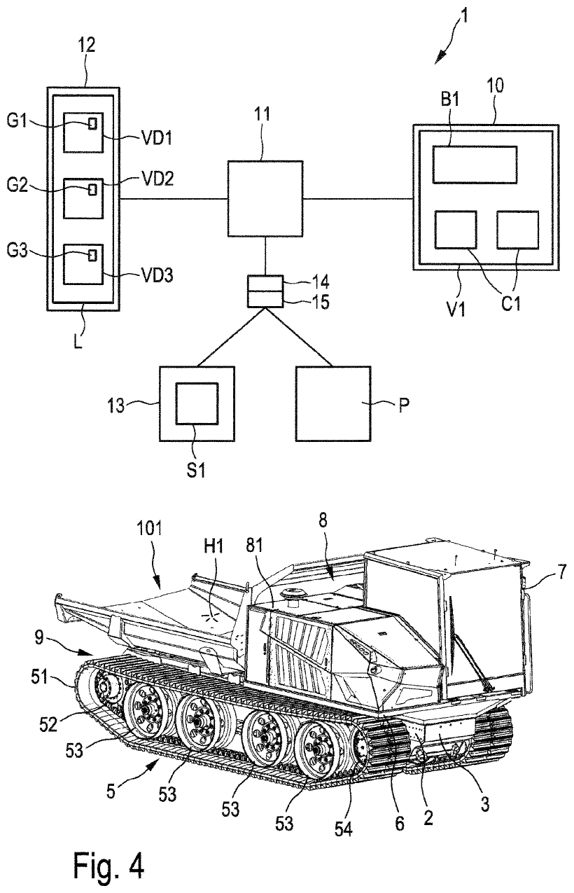

FIG. 4 shows the civilian tracked vehicle of FIGS. 1 to 3 in a view corresponding to FIG. 3, wherein an implement in the form of a dump body is mounted in an implement carrier area,

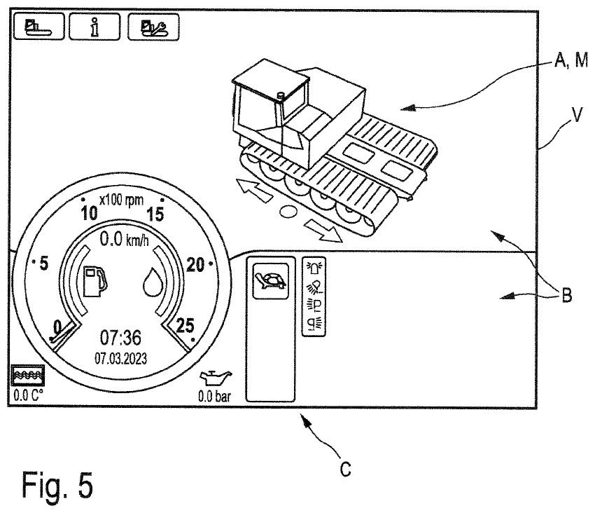

FIG. 5 shows visualization content of a touchscreen of the civilian tracked vehicle, wherein the visualization content relates to a base configuration of the civilian tracked vehicle without the implement,

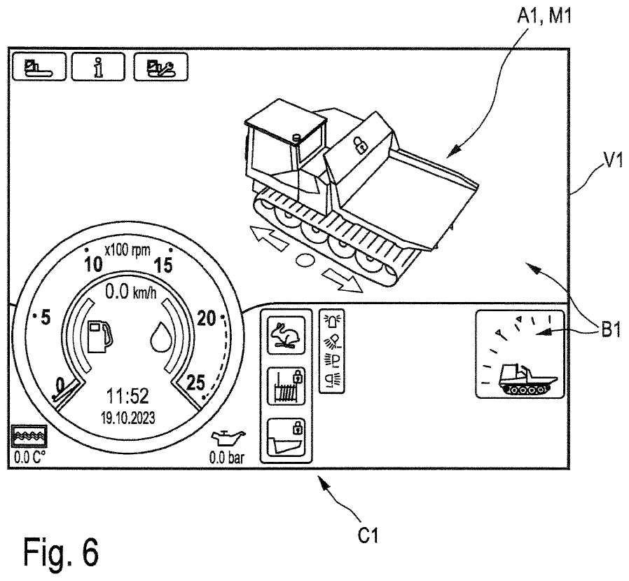

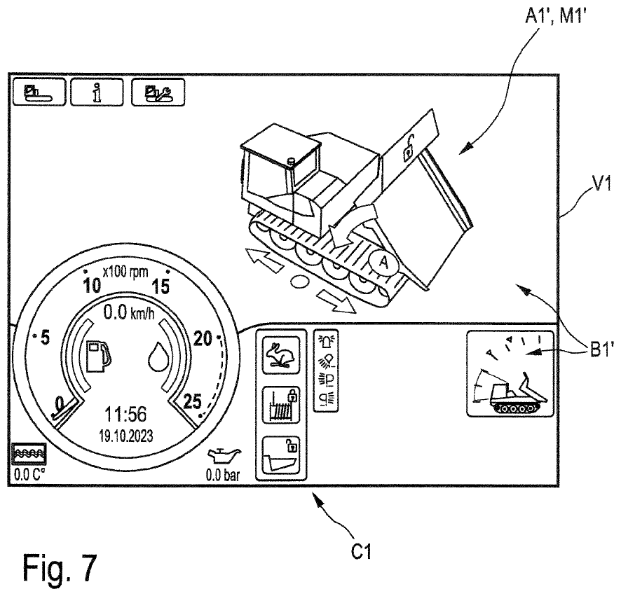

FIGS. 6, 7 show different states of the visualization content after mounting the implement and thus in a working configuration of the civilian tracked vehicle,

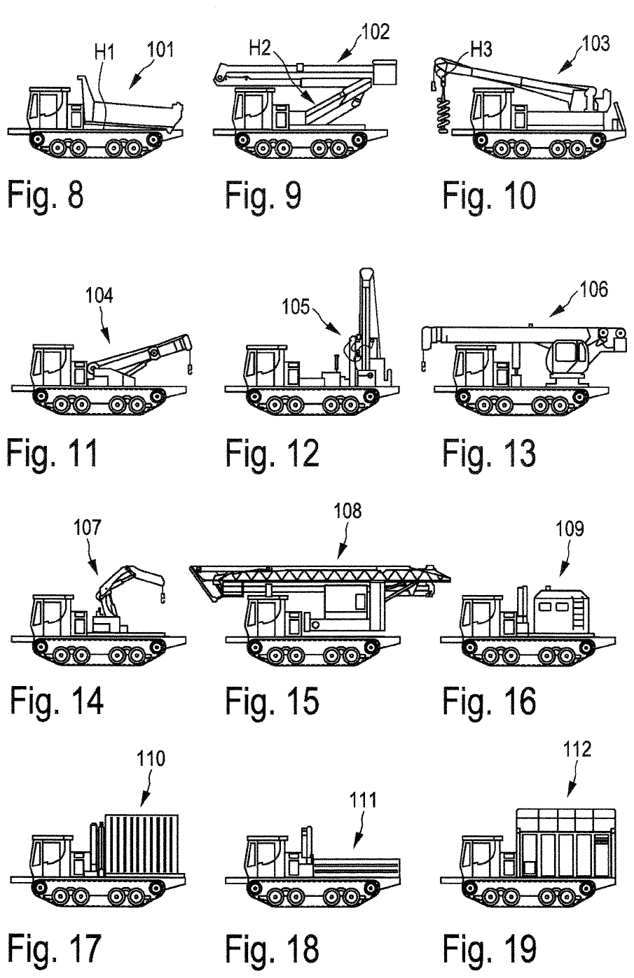

FIGS. 8 to 19 show side views of different implements in each case in the state mounted in the implement carrier area,

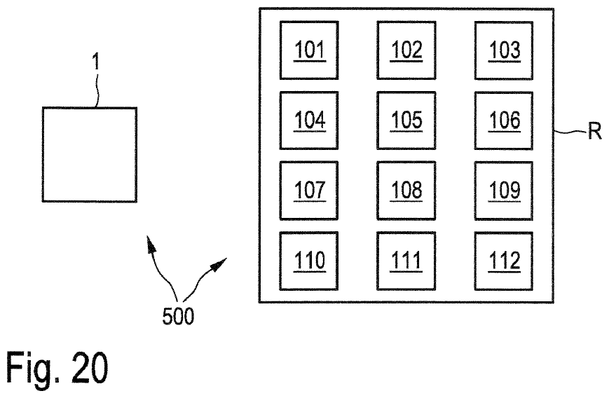

FIG. 20 is a schematic block diagram of an embodiment of a system according to the invention including a civilian tracked vehicle and a group of different implements and

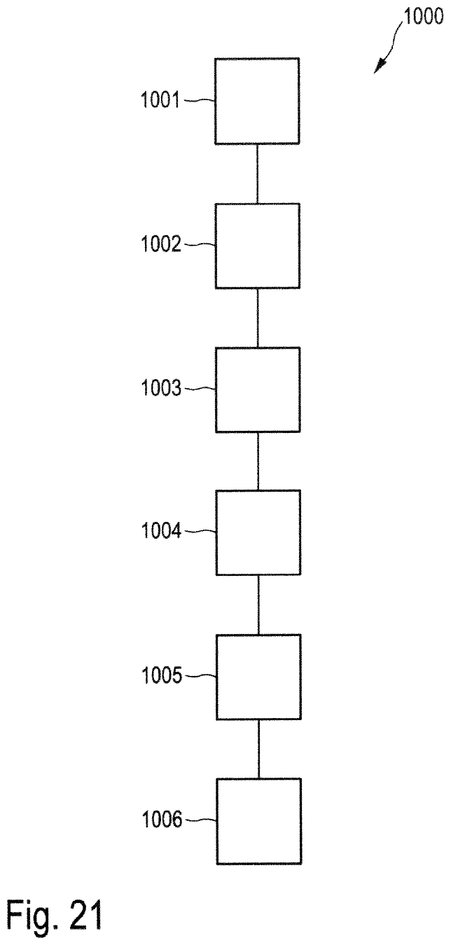

FIG. 21 is a schematic block diagram of an embodiment of a method according to the invention for operating the civilian tracked vehicle of FIGS. 1 to 4.

According to FIGS. 1 to 4, a civilian tracked vehicle 1 is provided for carrying out work tasks in difficult terrain. Depending on the type of task, the civilian tracked vehicle 1 can be provided with different implements 101 to 112 (see FIGS. 8 to 19) in a manner that will be described in greater detail. FIGS. 1 to 3 show the civilian tracked vehicle 1 in a base configuration without an implement. In FIG. 4, the civilian tracked vehicle 1 has an implement 101, which will be described in greater detail, such that this may also be denoted a working configuration of the civilian tracked vehicle 1.

The civilian tracked vehicle 1 (hereinafter “tracked vehicle” for short) has a support frame 2, two sets of tracked running gear 5, a body frame 6, a driver's cab 7, a drive system 8, an implement carrier area 9, a touchscreen 10, a data processing device 11 and a memory device 12.

The support frame 2 extends longitudinally between a front 3 and a rear 4 of the tracked vehicle 1. The support frame 2 can also be denoted main frame.

In the present case, the support frame 2 is arranged between the two sets of tracked running gear 5 in the transverse direction of the vehicle. In the present case, the support frame 2 does not protrude beyond the sets of tracked running gear 5 in the height direction of the vehicle.

The two sets of tracked running gear 5 are arranged on opposite longitudinal sides of the support frame 2 and form a track unit (with no reference sign).

In the embodiment shown, the sets of tracked running gear 5 in each case have a circulating track 51, a rear drive wheel 52, a plurality of support wheels 53 and a front tensioning wheel 54. The support wheels 53 and the tensioning wheel 54 are not driven. The support wheels 53 are of a larger diameter than the drive wheel 52 and/or the tensioning wheel 54. In the embodiment shown, the circulating track 51 is a continuous rubber track. In the present case, the sets of tracked running gear 5 in each case have four support wheels 53.

The body frame 6 is arranged on the support frame 2 and extends longitudinally across the support frame 2 from the front 3 toward the rear 4.

In the embodiment shown, the body frame only extends over part of the total length of the support frame 2. In addition, the body frame 6 is in the present case rigidly connected to the support frame 2. In one embodiment which is not shown in the figures, the body frame 6 is rotationally mobile relative to the support frame 2 about an axis of rotation arranged in the height direction of the vehicle. As in particular shown in FIG. 2, in the present case, the body frame 6 protrudes in the transverse direction of the vehicle over both sets of tracked running gear 5. Lateral portions of the body frame 6 in the transverse direction of the vehicle are arranged immediately above the sets of tracked running gear in a height direction of the vehicle.

The driver's cab 7 is arranged at the front of the body frame 6.

In the embodiment shown, the driver's cab 7 is arranged laterally offset relative to a vertical longitudinal plane of the tracked vehicle 1. In the present case, the driver's cab 7 provides sufficient space for one person, i.e., the driver of the tracked vehicle 1. No further space for a passenger is provided in the embodiment shown.

The drive system 8 is arranged on the body frame 6 and adjoins the driver's cab 7. The drive system 8 provides the drive energy for the tracked vehicle 1 and thus in particular for the sets of tracked running gear 5, an actuator system H1 of the implement 101 (FIG. 4) and any further consumers.

In the embodiment shown, the drive system 8 has an L-shaped configuration. One limb (with no reference sign) of this L-shaped configuration extends longitudinally along a rear side 71 of the driver's cab. A further limb of the L-shaped configuration extends longitudinally along a longitudinal side 72 of the driver's cab 7. In the embodiment shown, the drive system 8 has a central internal combustion engine, a hydraulic system coupled thereto and a fan unit (in each case with no reference sign). The above-stated components of the drive system 8 are concealed under an L-shaped housing 81 of the drive system 8. In the present case, the housing 81 extends around the driver's cab 7 in an L-shape over the entire length and width of the body frame 6.

The implement carrier area 9 is arranged at the rear of the driver's cab 7 and is used for mounting the various implements 101 to 112 (see FIGS. 8 to 19), wherein, in the working configuration according to FIG. 4, the implement 101 is mounted in the implement carrier area 9. For the purpose of mounting, the implement in question can be detachably fastened to the support frame 2 and/or body frame 6.

The touchscreen 10 is arranged in the driver's cab 7 and has visualization content V that is configured for outputting operating information B and for inputting operating commands C (see FIG. 3).

In the base configuration of the tracked vehicle 1 (FIGS. 1, 2, 3), the operating information B relates, in the absence of an implement, solely to the tracked vehicle 1, in particular to information relating to the state of the drive system 8, the sets of tracked running gear 5 and/or any other functional devices (e.g., headlights, air conditioning etc.) of the tracked vehicle 1. Accordingly, the inputtable operating commands C serve to control or also adjust the drive system 8, the sets of tracked running gear 5 and/or the other functional devices of the tracked vehicle 1.

In the working configuration with a mounted implement 101 (FIG. 4), the touchscreen 10 has an adapted or also differently configured visualization content V1.

The visualization content V1 in the working configuration differs from the visualization content V in the base configuration with regard to the nature and/or scope of the outputtable operating information B1 and/or the inputtable operating commands C1. In the working configuration, the operating information B1 and operating commands C1 alternatively or additionally relate to states and/or functions of the implement 101. Configuration of the visualization content of the touchscreen 10 between the base configuration and the working configuration takes place automatically in a manner that will be described in greater detail.

The data processing device 11 is connected to the touchscreen 10 and may for example be a central computer or control unit of the tracked vehicle 1. Alternatively, the data processing device 11 can be associated with the touchscreen 10 and thus be decentralized. The data processing device 11 is additionally connected to the memory device 12.

In one embodiment, the memory device 12 is a central memory device of the tracked vehicle 1. In a further embodiment, the memory device 12 is associated with the touchscreen 10 and is thus decentralized. A visualization data library L is stored in the memory device 12. The visualization data library L comprises a plurality of different visualization data sets VD1, VD2, VD3, wherein the number of three visualization data sets shown in FIGS. 3 and 4 should be taken to be purely exemplary. The different visualization data sets VD1, VD2, VD3 are in each case associated with one of the different implements 101 to 112.

FIGS. 8 to 19 show the different implements 101 to 112 by way of example. The implements 101 to 112 shown there are mountable in the implement carrier area 9 depending on the nature of the assignment to be carried out. The form and function of the different implements 101 to 112 will now be explained in greater detail.

The visualization data library L has a visualization data set for each of the different implements 101 to 112, such that in the present case it is not just the three visualization data sets shown here but at least twelve different visualization data sets that are stored. To simplify the description, only visualization data sets VD1, VD2 and VD3 are referred to below.

Visualization data set VD1 can also be denoted first visualization data set VD1 and is associated with implement 101 (FIGS. 4, 8) that can in turn be denoted first implement 101. In the present case, the first implement 101 is a dump body.

Visualization data set VD2 can also be denoted second visualization data set VD2 and is associated with the implement 102 shown in FIG. 9 that can also be denoted second implement 102. In the present case, the second implement 102 is a lifting platform.

Visualization data set VD3 can also be denoted third visualization data set VD3 and is associated with the implement 103 shown in FIG. 10 that can also be denoted third implement 103. In the present case, the third implement 103 is an auger.

As already explained, the visualization data library L includes still further visualization data sets, each of which is associated with one of the further implements 104 to 112. Said implements may also denoted fourth implement 104, fifth implement 105, sixth implement 106, seventh implement 107, eighth implement 108, ninth implement 109, tenth implement 110, eleventh implement 111 and twelfth implement 112.

In the embodiment shown, the fourth implement 104 is a jib crane, the fifth implement 105 is a vertical drilling rig, the sixth implement 106 is a telescopic crane, the seventh implement 107 is an articulated crane, the eighth implement 108 is a folding crane, the ninth implement 109 is a welding cabin, the tenth implement is a shipping container, the eleventh implement is a flatbed and the twelfth implement is another implement.

In the present case, the visualization content of the touchscreen 10 is adaptable to each individual one of the different implements 101 to 112 and thus to a total of twelve different working configurations as well as the base configuration of the tracked vehicle 1 shown in FIGS. 1 to 3. With reference to the working configuration shown in FIG. 4 with the first implement 101, this adaptation takes place as follows:

Once the first implement 101 has been selected and mounted in the implement carrier area 9, specification data S1 are read from a specification data memory 13. This reading is carried out by way of the data processing device 11.

As a function of the read specification data S1, one of the various visualization data sets in the visualization data library L is then selected. This selection is also carried out by way of the data processing device 11. Specification data S1 are associated with the first implement 101, such that the first visualization data set VD1 is consequently selected.

The visualization content of the touchscreen 10 is then configured as a function of the selected visualization data set VD1. This configuration is carried out by way of the data processing device 11. The configured visualization content V1 in FIG. 4 adapted to the first implement 101 can also be denoted first visualization content. The operating information B1 outputtable and operating commands C1 inputtable by way of the first visualization content V1 can consequently also be denoted first operating information B1 and first operating commands C1.

In the present case, a total of twelve different visualization contents corresponding to the number of different implements 101 to 112 are configurable, plus the visualization content V in the base configuration of the tracked vehicle 1 (FIGS. 1, 2, 3).

In the embodiment shown in the figures, the different implements 101 to 112 in each case include a specification data memory with associated specification data, wherein the specification data memories are not shown separately in FIGS. 8 to 19.

The specification data memory 13 shown in FIG. 4 is consequently part of the first implement 101. The specification data memory 13 is arranged at a location not specified in greater detail on the first implement 101 and is connectable to the data processing device 11 wirelessly or by wire.

In the present case, a data interface 15 that is associated with the first implement 101 is provided for the purpose of this connection. In the embodiment shown, the tracked vehicle 1 has a complementary data interface 14. The two data interfaces 14, 15 are connectable or connected wirelessly or by wire. In the embodiment shown, the data interfaces 14, 15 are a CAN bus.

The two data interfaces 14, 15 are preferably automatically connected to one another as soon as the first implement 101 is mounted in the implement carrier area 9.

In the embodiment shown, the visualization data sets VD1, VD2, VD3 in each case comprise display data G1, G2, G3 (see FIG. 4). These display data G1, G2, G3 in each case represent different views of the implement in question in different perspectives and/or in different operating states. These different views with regard to perspective and/or operating state can be displayed by way of the (configured) visualization content. Further details in this respect are explained below by way of example on the basis of FIGS. 5 to 7.

FIG. 5 shows the visualization content V of the touchscreen 10 in the base configuration of the tracked vehicle 10. The visualization content V comprises the above-mentioned operating information B and operating commands C. In the present case, the operating information B comprises a perspective view A of the tracked vehicle 1 in the base configuration. The perspective view A shown in FIG. 5 here relates to an operating state M of the tracked vehicle 1.

FIGS. 6 and 7 show the configured (first) visualization content V1 adapted to the first implement 101. In the present case, the first visualization content V1 in particular differs from visualization content V in the base configuration with regard to the nature and scope of the displayable or displayed operating information B1, B1′ and the nature and scope of the inputtable control commands C1. In the state shown in FIG. 6, the operating information B1 comprises a perspective view A1, in which the tracked vehicle 1 is shown in its first working configuration, i.e., together with the first implement 101. The first implement 101, in the present case the dump body, can assume different states during operation of the tracked vehicle 1, namely a fully lowered state (FIG. 4), a fully tilted state and intermediate positions (neither shown). The first visualization content V1 allows these different operating states to be displayed. In view A1 shown in FIG. 6, the dump body is lowered. In the operating state shown in FIG. 7, the dump body is tilted. The perspective views A1, A1′ shown in FIGS. 6 and 7 differ with regard to the operating state M1, M1′ shown in each case. The same applies mutatis mutandis with regard to the operating information B1, B1′ shown in each case.

In the present case, the data processing device 11 is configured to receive operating parameters P of the implement mounted in the implement carrier area 9. In the present case, the operating parameters P are transferred via the data interfaces 14, 15. The displayed operating information, in particular the views A1, A1′, can be modified on the basis of the received operating parameters P. The operating parameters P represent a current operating state of the implement. This operating state can then be displayed as a function of the transferred operating parameter P. For example, the first operating state M1 shown in FIG. 6 corresponds to a first operating parameter. The second operating state M1′ shown in FIG. 7 corresponds to a second operating parameter.

At least some of the different implements 101 to 112 shown in FIGS. 8 to 19 have an actuator system. The first implement 101 (dump body) has an actuator system H1 in the form of a hydraulic actuating cylinder not shown in greater detail for tilting and lowering the dump body. The second implement 102 (lifting platform) has an actuator system H2 for raising and lowering the lifting platform. Actuator system H2 comprises a plurality of hydraulic actuating cylinders not shown in greater detail. The third implement 103 (auger) has an actuator system H3 for rotating the auger. In the present case, the actuator system H3 is a hydraulic motor. The further implements 104 to 112 may also in each case have an actuator system in the form of hydraulic, pneumatic and/or electrically operated actuating cylinders or servomotors.

In the respective working configuration, the actuator systems of the implement in question are connected to the drive system 8.

In the (first) working configuration shown in FIG. 4, the actuator system H1 is connected to the drive system 8. The drive system 8 accordingly provides hydraulic drive energy for raising and lowering the (first) implement 101. The operating commands C1 required for raising and lowering are inputtable on the touchscreen 10. The (first) visualization content V1 is configured accordingly.

FIG. 20 shows a system 500 in schematically simplified form in a block diagram. The system 500 comprises the civilian tracked vehicle 1 and a group R that in the present case includes the different implements 101 to 112 according to FIGS. 8 to 19.

FIG. 21 is shows a method 1000 for operating the tracked vehicle 1 of FIGS. 1 to 4 in a schematic block diagram. In the embodiment shown, the method 1000 includes the following steps of: selecting an implement from the group R of different implements 101 to 112, wherein the first implement 101 is selected in the present case; mounting 1002 the selected implement 101 in the implement carrier area 9; reading 1003 the specification data S1 of the mounted implement 101 from the specification data memory 13 by way of the data processing device 11; selecting 1004 a visualization data set from the visualization data library L comprising said plurality of different visualization data sets VD1, VD2, VD3, each of which is associated with one of the different implements 101 to 112, wherein the first visualization data set VD1 is selected in the present case, and wherein selection is carried out by way of the data processing device 11 and as a function of the read specification data S1; configuring 1005 the visualization content V1 of the touchscreen 10, wherein configuration is carried out by way of the data processing device 11 and as a function of the selected visualization data set VD1; and operating 1006 the tracked vehicle 1 as a function of the configured visualization content V1 of the touchscreen 10.

1. A civilian tracked vehicle having
a support frame that extends longitudinally between a front and a rear of the tracked vehicle,
two sets of tracked running gear that are arranged on opposite longitudinal sides of the support frame,
a body frame that is arranged on the support frame and extends longitudinally across the support frame from the front toward the rear,
a driver's cab that is arranged at the front of the body frame,
a drive system; that is arranged on the body frame adjacent to the driver's cab and is configured to provide drive energy,
an implement carrier area that is arranged at the rear of the driver's cab on the support frame and/or the body frame and is configured for mounting different implements,
a touchscreen that is arranged in the driver's cab and has visualization content that is configured for outputting operating information and for inputting operating commands,
and a data processing device that is connected to the touchscreen,
wherein in that a memory device is present that is connected to the data processing device and in which is stored a visualization data library comprising a plurality of different visualization data sets, each of which is associated with one of the different implements,
in that the data processing device is configured to read, from a specification data memory, specification data that are associated with one implement; of the plurality of different implements to mountable or mounted in the implement carrier area,
in that the data processing device is configured to select a visualization data set from the plurality of different visualization data sets; as a function of the read specification data,
and in that the data processing device is configured to configure the visualization content of the touchscreen as a function of the selected visualization data set.

2. The civilian tracked vehicle as claimed in claim 1, wherein the different visualization data sets in each case comprise display data that represent different views of the implement in question in different perspectives and/or in different operating states.

3. The civilian tracked vehicle as claimed in claim 2, wherein in that one implement of the plurality of different implements the is mounted in the implement carrier area.

4. The civilian tracked vehicle as claimed in claim 3, wherein the data processing device is connected to a data interface of the implement.

5. The civilian tracked vehicle as claimed in claim 4, wherein the implement includes the specification data memory, wherein the data processing device is configured to read the specification data from the specification data memory via the data interface.

6. The civilian tracked vehicle as claimed in claim 4, wherein the data processing device is configured to receive operating parameters of the implement, and in that the visualization content of the touchscreen is configured to output the operating information as a function of the received operating parameters.

7. The civilian tracked vehicle as claimed in claim 3, wherein in the implement has an actuator system that is connected to the drive system and is controllable via operating commands of the visualization content inputtable on the touchscreen.

8. The civilian tracked vehicle as claimed in claim 3, wherein the implement mounted in the implement carrier area is selected from a group of different implements, wherein the group comprises a dump body, a lifting platform, an auger, a jib crane, a vertical drilling rig, a telescopic crane, an articulated crane, a folding crane, a welding cabin, a shipping container, a flatbed and/or another implement.

9. A system including a civilian tracked vehicle as claimed in claim 1 and with a group of implements that are in each case mountable in the implement carrier area of the tracked vehicle, wherein the group comprises a dump body, a lifting platform, an auger, a jib crane, a vertical drilling rig, a telescopic crane, an articulated crane, a folding crane, a welding cabin, a shipping container, a flatbed and/or another implement.

10. A method for operating a civilian tracked vehicle, the tracked vehicle having
a support frame that extends longitudinally between a front and a rear of the tracked vehicle,
two sets of tracked running gear that are arranged on opposite longitudinal sides of the support frame,
a body frame that is arranged on the support frame and extends longitudinally across the support frame from the front toward the rear,
a driver's cab that is arranged at the front of the body frame,
a drive system that is arranged on the body frame adjacent to the driver's cab and is configured to provide drive energy,
an implement carrier area that is arranged at the rear of the driver's cab on the support frame and/or the body frame and is configured for mounting different implements,
a touchscreen that is arranged in the driver's cab and has visualization content that is configured for outputting operating information and for inputting operating commands,
and a data processing device that is connected to the touchscreen,
the method including the following steps of:
selecting an implement from a group of different implements;
mounting the selected implement in the implement carrier area;
reading specification data of the mounted implement from a specification data memory by way of the data processing device;
selecting a visualization data set from a visualization data library comprising a plurality of different visualization data sets, each of which is associated with one of the different implements, wherein selection is carried out by way of the data processing device and as a function of the read specification data;
configuring the visualization content of the touchscreen, wherein configuration is carried out by way of the data processing device and as a function of the selected visualization data set; and
operating the tracked vehicle as a function of the configured visualization content of the touchscreen.

11. The method as claimed in claim 10, wherein the selected visualization data set comprises display data that represent different views of the implement in different perspectives and/or in different operating states.

12. The method as claimed in claim 10, wherein a data interface of the mounted implement is being connected to the data processing device.

13. The method as claimed in claim 12, wherein the mounted implement includes the specification data memory, and wherein the specification data are read from the specification data memory via the data interface.

14. The method as claimed in claim 12, wherein operating parameters of the mounted implement are transferred to the data processing device via the data interface, and wherein the operating information is output on the touchscreen by way of the configured visualization content as a function of the transferred operating parameters.

15. The method as claimed in claim 10, wherein an actuator system of the mounted implement is being connected to the drive system, and wherein the actuator system is controlled via operating commands of the configured visualization content that are input on the touchscreen.
